(19) United States
(12) Patent Application Publication
(10) Pub. No.: US 2024/0258844 A1
(43) Pub. Date: Aug. 1, 2024

(54) WIRELESS POWER FEEDING SYSTEM AND METHOD

(71) Applicants: Laurel Bank Machines Co., LTD, Minato-ku, Tokyo (JP); Laurel Machinery Co., LTD, Osaka-shi, Osaka (JP); Laurel Precision Machines Co., LTD, Osaka-shi, Osaka (JP); Tokyo Institute of Technology, Tokyo (JP)

(72) Inventors: Hideyuki NAKANISHI, Minatu-ku, Tokyo (JP); Toshiki OHORI, Merguro-ku, Tokyo (JP); Wataru HIJIKATA, Meguro-ku, Tokyo (JP); Xiang LI, Minato-ku, Tokyo (JP); Shigeki OZAWA, Minato-ku, Tokyo (JP)

(21) Appl. No.: 18/564,081

(22) PCT Filed: May 16, 2022
(86) PCT No.: PCT/JP2022/020379

§ 371 Date: Nov. 25, 2023

(30) Foreign Application Priority Data
Jun. 3, 2021 (JP) 2021-093928

(51) Int. Cl. H02J 50/90; H02J 50/12; H02J 50/40

(52) U.S. Cl. CPC H02J 50/90; H02J 50/12; H02J 50/40

(57) ABSTRACT

A wireless power feeding system and method in which a positional relationship between a power transmission device and a power reception device is grasped to perform power transmission and reception without deteriorating the mobility of a moving body on which the power reception device is mounted. The system transmits power using a magnetic field resonance method includes power transmission devices including power transmission coils, a power reception device including a power reception coil that receives AC power having a first frequency from each of the power transmission coils and a transmission circuit that outputs an AC signal having a second frequency different from the first frequency and transmits the AC signal from the power reception coil, and a position estimation device that estimates a position of the power reception coil relative to the power transmission devices based on the strength of the AC signal from the power reception coil to the power transmission devices.

### TECHNICAL FIELD

The present invention relates to a wireless power feeding system and method.

### BACKGROUND ART

In recent years, a wireless power feeding system using magnetic field resonance coupling (magnetic field resonance) has been researched and developed. Magnetic field resonance coupling means a state where oscillation of a magnetic field generated by an AC current flowing through a resonance circuit in a power transmission device is transmitted to a resonance circuit in a power reception device to resonate so that magnetic fields respectively generated by coils of the resonance circuits are firmly coupled to each other. Wireless power feeding using magnetic field resonance coupling has an advantage that a power feedable distance is longer than that in wireless power feeding using conventional electromagnetic induction (magnetic field coupling).

Patent Literature 1 discloses a configuration in which many power feeding coils L1 are arranged in a matrix shape to transmit power from each of the power feeding coils L1 to a resonance coil L2 and make how to place a power reception device 200 have a degree of freedom. Patent Literature 1 discloses a configuration in which a position of the power reception device 200 is detected when a transmission circuit 203 drives a coil L3 at a predetermined frequency to reduce power consumption of the required power feeding coil L1 by driving only the power feeding coil L1 and a resonance coil L0b physically closest to the coil L3 detects a signal from the power reception device 200. Reference signs are described in Patent Literature 1.

### CITATION LIST

### Patent Literature

Patent Literature 1: Japanese Patent Laid-Open No. 2006-149168

### SUMMARY OF INVENTION

### Technical Problem

However, when the power reception device 200 is provided with the above-described coil L3, the weight of the device increases by the weight of the coil L3, and the size of the device increases. Accordingly, there has been a problem that the mobility of a moving body such as an AGV (automatic guided vehicle) deteriorates when the power reception device 200 is mounted on the moving body.

Further, interference may occur between the resonance coil L2 and the coil L3. Accordingly, there has been a problem that combined mounting of the resonance coil L2 and the coil L3 on the power reception device 200 lacks practicability.

There has occurred a technical problem to be solved to stably perform power transmission and reception by grasping a positional relationship between a power transmission device and a power reception device with high accuracy without deteriorating the mobility of a moving body on which the power reception device is mounted, and the present invention has its object to solve this problem.

### Solution to Problem

To attain the above-described object, a wireless power feeding system according to the present invention is a wireless power feeding system that transmits power using a magnetic field resonance method, the wireless power feeding system including a plurality of power transmission devices respectively including power transmission coils, a power reception device including a power reception coil that receives AC power having a first frequency from each of the power transmission coils and a transmission circuit that outputs an AC signal having a second frequency as a frequency different from the first frequency and transmits the AC signal from the power reception coil, and a position estimation device that estimates a position of the power reception coil relative to the power transmission devices on the basis of the strength of the AC signal that has propagated from the power reception coil to each of the power transmission devices.

To attain the above-described object, a wireless power feeding system according to the present invention is a wireless power feeding system that transmits power using a magnetic field resonance method, the wireless power feeding system including a plurality of power transmission devices respectively including power transmission coils, a power reception device including a power reception coil that receives AC power having a first frequency from each of the power transmission coils and a transmission circuit that outputs an AC signal having a frequency equal to the first frequency or within a predetermined range with respect to the first frequency and transmits the AC signal from the power reception coil, and a position estimation device that estimates a positional relationship between the power transmission devices and the power reception device on the basis of the strength of the AC signal that has propagated from the power reception coil to each of the power transmission devices.

To attain the above-described object, a wireless power feeding method according to the present invention is a wireless power feeding method using a wireless power feeding system that transmits power using a magnetic field resonance method and includes a plurality of power transmission devices respectively including power transmission coils, a power reception device including a power reception coil that receives AC power having a first frequency from each of the power transmission coils and a transmission circuit that outputs an AC signal having a second frequency as a frequency different from the first frequency and transmits the AC signal from the power reception coil, a controller that controls power to be fed to the plurality of power transmission devices, and a position estimation device that estimates a positional relationship between the power transmission devices and the power reception coil on the basis of the strength of the AC signal that has propagated from the power reception coil to each of the power transmission devices, in which the controller feeds the power to at least one of the plurality of power transmission devices depending on the positional relationship between the power transmission devices and the power reception coil, which has been estimated by the position estimation device.

### Advantageous Effect of Invention

The present invention makes it possible to stably perform position detection and power transmission and reception of a power reception device without deteriorating the mobility of a moving body on which the power reception device is mounted.

### BRIEF DESCRIPTION OF DRAWINGS

FIG. 1 is a schematic view illustrating an outline of a wireless power feeding system according to the present invention.

FIG. 2 is a schematic view illustrating a configuration of a wireless power feeding system according to a first embodiment of the present invention.

FIG. 3 is a schematic view illustrating a configuration of a wireless power feeding system according to a second embodiment of the present invention.

### DESCRIPTION OF EMBODIMENTS

### First Embodiment

A wireless power feeding system 1 according to a first embodiment of the present invention will be described with reference to the drawings. Hereinafter, when reference is made to the number of components or a numerical value, amount, range, or the like of each of the components, the number or the like is not limited to a particular number but may be the particular number or more or the particular number or less unless otherwise stated or except when expressly limited to the particular number in principle.

When reference to a shape of each of components and a positional relationship among the components, a substantially approximate or similar shape or the like is included unless otherwise stated or except when considered to be expressly excluded in principle.

In the drawings, there is a case where characteristic portions are exaggerated by being enlarged, for example, in order to facilitate the understanding of features, and a dimension ratio or the like of each of the components is not necessarily the same as an actual one. In a cross-sectional view, hatching of some of the components may be omitted in order to facilitate the understanding of a cross-sectional structure of the components.

### <Configuration of Wireless Power Feeding System>

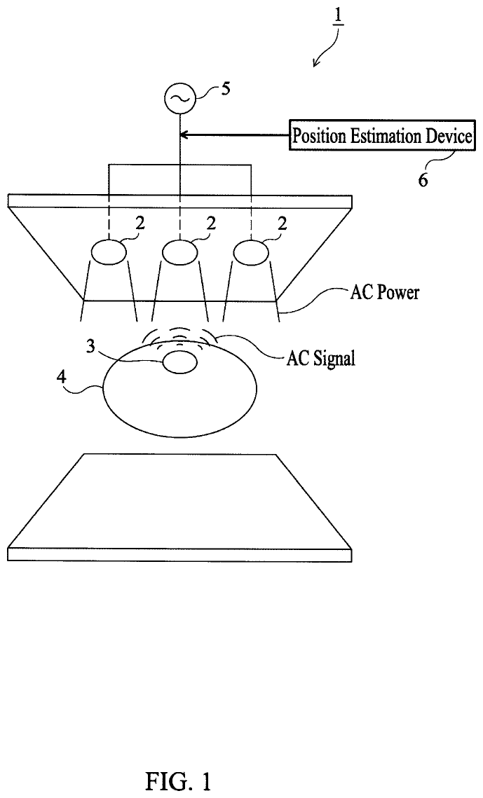

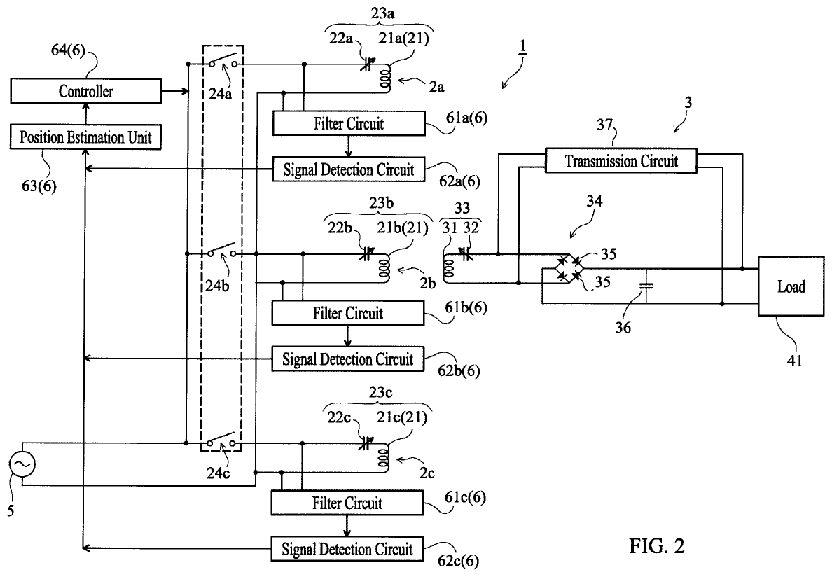

FIG. 1 is a schematic view illustrating an outline of a wireless power feeding system 1. FIG. 2 is a schematic view illustrating a configuration of the wireless power feeding system 1. The wireless power feeding system 1 includes a power transmission device 2 and a power reception device 3, and feeds power from the power transmission device 2 to the power-fed target 3 in a non-contact manner using magnetic field resonance coupling (magnetic field resonance).

Three power transmission devices 2 are provided in a line above a moving body 4 on which the power reception device 3 is mounted. An AC power supply 5 connected to each of the power transmission devices 2 feeds AC power to the power transmission device 2. Although the AC power is set to have a frequency of 150 kHz and a voltage of 10 V, for example, a frequency and a voltage of the AC power supply 5 can be arbitrarily changed.

An example of the moving body 4 is a robot flying object that movably floats within a predetermined space with the AC power received by the power reception device 3, but is not limited to this. Examples may be a vehicle, an underwater robot, a capsule endoscope, and a cardiac pacemaker.

The wireless power feeding system 1 includes a position estimation device 6 that drives only the power transmission device 2, which is closest to the power reception device 3, among the above-described plurality of power transmission devices 2 and does not drive the other power transmission devices 2 to reduce power consumption of the power transmission device 2. A configuration of the position estimation device 6 will be described below.

In the following description, the three power transmission devices 2 are respectively assigned reference numerals with suffixes a to c when distinguished. Various types of components respectively corresponding to the power transmission devices 2a to 2c are also similarly respectively assigned reference numerals with suffixes a to c.

### <Configuration of Power Transmission Device>

As illustrated in FIG. 2, the power transmission device 2a includes a power transmission coil 21a and a capacitor 22a. The power transmission coil 21a and the capacitor 22a are connected in series, to constitute a power feeding-side resonance circuit 23a. When an AC voltage having a frequency corresponding to a resonance frequency of the power feeding-side resonance circuit 23a set by an inductance of the power transmission coil 21a and a capacitance of the capacitor 22a flows through the power transmission coil 21a, an oscillating magnetic field occurs to penetrate the power transmission coil 21a in a coil axial direction.

Similarly, the power transmission device 2b includes a power feeding-side resonance circuit 23b configured by connecting a power transmission coil 21b and a capacitor 22b in series. When an AC voltage having a frequency corresponding to a resonance frequency of the power feeding-side resonance circuit 23b set by an inductance of the power transmission coil 21b and a capacitance of the capacitor 22b flows through the power transmission coil 21b, an oscillating magnetic field occurs to penetrate the power transmission coil 21b in a coil axial direction.

The power transmission device 2c includes a power feeding-side resonance circuit 23c configured by connecting a power transmission coil 21c and a capacitor 22c in series. When an AC voltage having a frequency corresponding to a resonance frequency of the power feeding-side resonance circuit 23c set by an inductance of the power transmission coil 21c and a capacitance of the capacitor 22c flows through the power transmission coil 21c, an oscillating magnetic field occurs to penetrate the power transmission coil 21c in a coil axial direction.

The power transmission coils 21a to 21c are formed by winding a copper wire or the like having a high electrical conductivity in a circular shape. A larger amount of current flows in the copper wire in the vicinity of a surface of the copper wire than in a central portion of the copper wire due to an influence of an internal resistance. Therefore, a litz wire obtained by twisting a plurality of copper wires together is used as a wire material for the power transmission coils 21a to 21c, the surface area of the litz wire is larger than that of one of the copper wires having the same diameter. Accordingly, a larger amount of current can be made to flow, thereby making it possible to suppress a current loss.

A switch 24a is connected in series with the power feeding-side resonance circuit 23a. A switch 24b is connected in series with the power feeding-side resonance circuit 23b, and a switch 24c is connected in series with the power feeding-side resonance circuit 23c. The switches 24a to 24c are controlled to open and close by a controller 64, described below.

### <Configuration of Power Transmission Device>

As illustrated in FIG. 2, the power reception device 3 includes a power reception coil 31 and a capacitor 32.

The power reception coil 31 and the capacitor 32 are connected in series, to constitute a power reception-side resonance circuit 33. A resonance frequency of the power reception-side resonance circuit 33 set by an inductance of the power reception coil 31 and a capacitance of the capacitor 32 is set to match respective resonance frequencies of the power feeding-side resonance circuits 23a to 23c. As a result, an induced current flows through the power reception coil 31 due to oscillation of a magnetic field that has occurred to penetrate the power transmission coil 21 in the coil axial direction, an oscillating magnetic field occurs to penetrate the power reception coil 31 in a coil axial direction, and the respective magnetic fields of the power transmission coils 21a to 21c and the power reception coil 31 resonate, to be firmly coupled to each other.

The power reception coil 31 is formed by winding a copper wire or the like having a high electrical conductivity in a circular shape. The power reception coil 31 also preferably uses a litz wire as a wire material, like the power transmission coil 21.

AC power resonantly received by the power reception coil 31 is fed to a load 41 via a rectifying circuit 34. The load 41 is a motor, a battery, or the like constituting the moving body 4.

The rectifying circuit 34 is a diode bridge circuit having four diodes 35 arranged on its bridge, to full-wave rectify the AC power received by the power reception coil 31 and output a DC voltage. The DC voltage outputted by the rectifying circuit 34 is smoothed by a capacitor 36. The rectifying circuit 34 is not limited to the illustrated diode bridge circuit.

The power reception device 3 includes a transmission circuit 37. The transmission circuit 37 is driven with power outputted by the rectifying circuit 34, and outputs an AC signal having a predetermined frequency to the power reception coil 31. The AC signal outputted from the transmission circuit 37 is transmitted toward the power transmission devices 2a to 2c from the power reception coil 31.

### <Configuration of Position Estimation Device>

The position estimation device 6 can estimate a position of the power reception device 3 (the power reception coil 31) relative to the power transmission devices 2a to 2c. As illustrated in FIG. 2, the position estimation device 6 includes filter circuits 61a to 61c, signal detection circuits 62a to 62c, a position estimation unit 63, and a controller 64.

The filter circuits 61a to 61c are respectively connected to correspond to the power transmission coils 21a to 21c. The filter circuit 61a separates AC power and an AC signal received by the power transmission coil 21a, which are mixed in the power feeding-side resonance circuit 23a, from each other, to extract the AC signal. Similarly, the filter circuit 61b separates AC power and an AC signal received by the power transmission coil 21b, which are mixed in the power feeding-side resonance circuit 23b, from each other, to extract the AC signal, and the filter circuit 61c separates AC power and an AC signal received by the power transmission coil 21c, which are mixed in the power feeding-side resonance circuit 23c, from each other, to extract the AC signal.

That is, the AC powers generated from the power transmission coils 21a to 21c and the AC signals outputted by the transmission circuit 37 and received by the power transmission coils 21a to 21c are respectively fed in a mixed state toward the AC power supply 5 side of the power transmission coils 21a to 21c, thereby making it difficult to extract only the AC signal with high accuracy. The filter circuits 61a to 61c provided on the AC power supply 5 side of the power transmission coils 21a to 21c can respectively pass only the AC signals received by the power transmission coils 21a to 21c by separating the AC powers generated from the power transmission coils 21a to 21c and the AC signals outputted by the transmission circuit 37 and received by the power transmission coils 21a to 21c from each other.

The signal detection circuits 61a to 62c are respectively connected to correspond to the filter circuits 61a to 61c. The signal detection circuit 62a detects the strength of the AC signal extracted by the filter circuit 61a. Similarly, the signal detection circuit 62b detects the strength of the AC signal extracted by the filter circuit 61b, and the signal detection circuit 62c detects the strength of the AC signal extracted by the filter circuit 61c. The signal detection circuits 62a to 62c are respectively driven by DC power supplies not illustrated independent of one another.

The position estimation unit 63 estimates a position of the power reception device 3 (the power reception coil 31) relative to the power transmission devices 2a to 2c on the basis of the strength of the AC signal detected by each of the signal detection circuits 62a to 62c. The controller 64 performs on/off control of the switches 24a to 24c, to turn on any one of the switches 24a to 24c that corresponds to the position of the power reception device 3 (the power reception coil 31) and turn off the others of the switches 24a to 24c.

Then, a function of the wireless power feeding system 1 will be described with reference to the drawings.

### <Initial Power Transmission>

First, if AC power is sequentially fed to all or at least any one of the three power transmission coils 21, when the power transmission coil 21 closest to the power reception device 3 is energized, an oscillating magnetic field occurs to penetrate the energized power transmission coil 21 in the coil axial direction. An induced current flows through the power reception coil 31 due to magnetic field oscillation, and an oscillating magnetic field occurs to penetrate the power reception coil 31 in the coil axial direction. Thus, the respective magnetic fields of the energized power transmission coil 21 and the power reception coil 31 resonate, to be firmly coupled to each other, and AC power having a first frequency (e.g., 150 kHz) is transmitted from the power transmission coil 21 to the power reception coil 31.

AC power to be fed to the power reception device 3 from the power transmission device 2 in initial power transmission may be power small enough to drive the transmission circuit 37.

### <Signal Transmission>

Then, the transmission circuit 37 is driven by a DC voltage received by the power reception coil 31 and rectified by the rectifying circuit 34. The transmission circuit 37 outputs a weak AC signal to the power reception coil 31.

The frequency of the AC signal to be outputted by the transmission circuit 37 is set to a first frequency and a second frequency (e.g., several thousand kilohertz) as a frequency different from its harmonic to prevent the AC signal from interfering with AC power.

The second frequency is preferably set to a frequency exceeding a frequency band in which the rectifying circuit 34 can be driven or a frequency at which the rectification efficiency of the rectifying circuit 34 is a predetermined ratio (e.g., 1/10) or less. Particularly when a diode bridge circuit is used as the rectifying circuit 34, the second frequency is preferably set to a frequency exceeding a response frequency of the diode 35 or a frequency at which an output of the diode 35 is lower than a predetermined threshold value (e.g., 1/10) of a DC characteristic.

### <Position Estimation>

When an AC signal propagates from the power reception coil 31 to the power transmission devices 2a to 2c and the power transmission coils 21a to 21c the magnetic fields of which resonate with that of the power reception coil 31 respectively receive AC signals each having a second frequency transmitted from the power reception coil 31, the filter circuits 61a to 61c respectively interrupt AC powers each having a first frequency existing in the power feeding-side resonance circuits 23a to 23c and pass the AC signals each having the second frequency. The signal detection circuits 62a to 62c respectively detect the strengths of the AC signals that have passed through the filter circuits 61a to 61c.

Then, the position estimation unit 63 estimates any one of the power transmission devices 2a to 2c that is closest to the power reception coil 31 depending on the strength of the AC signal detected by each of the signal detection circuits 62a to 62c. Specifically, the position estimation unit 63 compares the strengths of the AC signals respectively detected by the signal detection circuits 62a to 62c and estimates that the power transmission device 2 corresponding to any one of the signal detection circuits 62a to 62c that has received the AC signal having the highest strength is closest to the power reception coil 31.

In the present embodiment illustrated in FIG. 2, the power reception device 3 (the power reception coil 31) is at a position closest to the power transmission device 2b. Accordingly, the respective magnetic fields of the power reception coil 31 and the power transmission coil 21b resonate with each other, and the AC signal transmitted from the power reception coil 31 is received in the power transmission coil 21b with a high strength.

On the other hand, the power reception device 3 (the power reception coil 31) is at a position offset in a coil radial direction from the power transmission devices 2a and 2c, and respective distances between the power transmission devices 2a and 2c and the power reception coil 31 are longer than a distance between the power transmission device 2b and the power reception coil 31. Therefore, the respective magnetic fields of the power reception coil 31 and the power transmission coils 21a and 21c do not resonate with each other or enter a very weak resonance state, and the AC signal transmitted from the power reception coil 31 is not received or is received with a very low strength by the power transmission coils 21a and 21c.

Hereinafter, a case where the power transmission device 2b is closest to the power reception coil 31, as described above, will be described as an example.

The controller 64 turns on the switch 24b corresponding to the power transmission device 2b that has been selected as being closest to the power reception coil 31 by the position estimation unit 63 and turns off the switches 24a and 24c respectively corresponding to the other power transmission devices 2a and 2c.

### <Present Transmission>

The respective magnetic fields of the energized power transmission coil 21b and the power reception coil 31 resonate, to be firmly coupled to each other, and the AC power having the first frequency is efficiently transmitted from the power transmission coil 21b to the power reception coil 31.

Initial power transmission from the power transmission coil 21 to the power reception coil 31 is preferably performed in a predetermined cycle (e.g., every five seconds). As a result, even when the moving body 4 moves, the power transmission device 2 closest to the power reception coil 31 can be selected in real time to follow the movement of the moving body 4.

For example, when the power reception device 3 moves from the vicinity of the power transmission device 2b to the vicinity of the power transmission device 2c as the moving body 4 moves, the strength of the AC signal to be detected by the signal detection circuit 62b gradually decreases, while the strength of the AC signal to be detected by the signal detection circuit 62c gradually increases. If the controller 64 turns off the switch 24b and turns on the switch 24c at a timing at which the strength of the AC signal is reversed, power transmission to the power reception device 3 is performed without interruption so that most efficient power transmission can be performed. When both the switches 24b and 24c are turned on before and after the timing at which the strength of the AC signal is reversed, the stability of the power transmission can be further enhanced.

Thus, the wireless power feeding system 1 according to the present embodiment is the wireless power feeding system 1 that transmits power using a magnetic field resonance method, the wireless power feeding system 1 being configured to include the power transmission devices 2a to 2c respectively including the power transmission coils 21, the power reception device 3 including the power reception coil 31 that receives AC power having a first frequency from each of the power transmission coils 21 and the transmission circuit 37 that outputs an AC signal having a second frequency as a frequency different from the first frequency and transmits the AC signal from the power reception coil 31, and the position estimation device 6 that estimates a positional relationship between the power transmission devices 2a to 2c and the power reception coil 31 on the basis of the strength of the AC signal that has propagated from the power reception coil 31 to each of the power transmission devices 2a to 2c.

According to this configuration, the transmission circuit 37 outputs the AC signal set to the frequency that is not synchronized with the AC power, the power reception coil 31 is used for both reception of the AC power and transmission of the AC signal, and the position estimation device 6 estimates the positional relationship between the power transmission devices 2a to 2c and the power reception coil 31 on the basis of the strength of the AC signal received by each of the power transmission coils 21, thereby making it possible to stably transmit and receive power by grasping the positional relationship between the power transmission devices 2a to 2c and the power reception device 3 with high accuracy and further making it possible to make the moving body 4 light in weight and small in size.

The wireless power feeding system 1 according to the present embodiment is configured such that the position estimation device 6 includes the filter circuits 61a to 61c that are respectively connected to correspond to the power transmission coils 21a to 21c and respectively interrupt the AC powers and pass the AC signals received by the power transmission coils 21a to 21c and the position estimation unit 63 that estimates any one of the power transmission coils 21a to 21c that is closest to the power reception coil 31 on the basis of the strength of the AC signal that has passed through each of the filter circuits 61a to 61c.

According to this configuration, the filter circuits 61a to 61c respectively extract AC signals from among signals having a plurality of frequency components existing in the power transmission devices 2a to 2c, and the position estimation unit 63 estimates any one of the power transmission coils 21a to 21c that is closest to the power reception coil 31 on the basis of the strength of the AC signal extracted by each of the filter circuits 61a to 61c, thereby making it possible to stably perform power transmission and reception by grasping the positional relationship between the power transmission devices 2a to 2c and the power reception device 3 with high accuracy.

The wireless power feeding system 1 according to the present embodiment is configured such that the power reception device 3 further includes the rectifying circuit 34 that is provided between the power reception coil 31 and the load 41 to be fed with the AC power and can be driven in a predetermined frequency band and the second frequency is set to a frequency exceeding the predetermined frequency band or a frequency at which the rectification efficiency of the rectifying circuit 34 is a predetermined ratio or less.

This configuration makes it possible to prevent the AC signal from interfering with the rectifying circuit 34 in the power reception device 3.

The wireless power feeding system 1 according to the present embodiment is configured such that the rectifying circuit 34 is a diode bridge circuit having the plurality of diodes 35 and the second frequency is set to a frequency exceeding a response frequency of each of the diodes 35 or a frequency at which an output of the diode 35 is lower than a predetermined threshold value of a DC characteristic.

This configuration makes it possible to prevent the AC signal from interfering with the diode bridge circuit including the diodes 35.

The wireless power feeding method according to the present embodiment is the wireless power feeding method using the wireless power feeding system 1 that transmits power using a magnetic field resonance method and includes the power transmission devices 2a to 2c respectively including the power transmission coils 21, the power reception device 3 including the power reception coil 31 that receives AC power having a first frequency from each of the power transmission coils 21 and the transmission circuit 37 that outputs an AC signal having a second frequency as a frequency different from the first frequency and transmits the AC signal from the power reception coil 31, and the position estimation device 6 that estimates a positional relationship between the power transmission devices 2a to 2c and the power reception coil 31 on the basis of the strength of the AC signal that has propagated from the power reception coil 31 to each of the power transmission devices 2a to 2c, in which the controller 64 is configured to feed power to at least one of the plurality of power transmission devices 2a to 2c depending on the positional relationship between the power transmission devices 2a to 2c and the power reception coil 31, which has been estimated by the position estimation device 6.

According to this configuration, the transmission circuit 37 outputs the AC signal set to the frequency that is not synchronized with the AC power, the power reception coil 31 is used for both reception of the AC power and transmission of the AC signal, and the position estimation device 6 estimates the positional relationship between the power transmission devices 2a to 2c and the power reception coil 31 on the basis of the strength of the AC signal received by each of the power transmission coils 21, thereby making it possible to stably perform power transmission and reception by grasping the positional relationship between the power transmission devices 2a to 2c and the power reception device 3 with high accuracy and further making it possible to make the moving body 4 light in weight and small in size.

### Second Embodiment

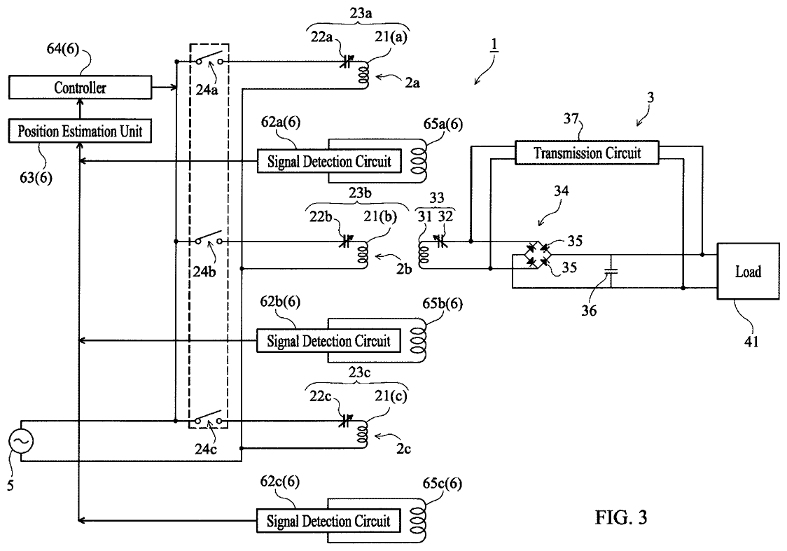

Then, a wireless power feeding system 1 according to a second embodiment of the present invention will be described with reference to FIG. 3. The wireless power feeding system 1 according to the present embodiment differs in only a configuration of a position estimation device 6 from that in the above-described wireless power feeding system 1 according to the first embodiment. Accordingly, other common components are respectively assigned the same reference numerals, and overlapping description is omitted.

The position estimation device 6 includes antenna coils 65a to 65c, signal detection circuits 62a to 62c, and a position estimation unit 63.

The antenna coils 65a to 65c are respectively provided to correspond to any positions (e.g., left and right, front and rear, or top and bottom) in the vicinities of power transmission coils 21a to 21c, and respectively receive AC signals transmitted from a power reception coil 31. That is, the antenna coil 65a receives the AC signal transmitted toward the power transmission coil 21a from the power reception coil 31. Similarly, the antenna coil 65b receives the AC signal transmitted toward the power transmission coil 21b from the power reception coil 31, and the antenna coil 65c receives the AC signal transmitted toward the power transmission coil 21c from the power reception coil 31.

The signal detection circuits 62a to 62c are respectively connected to correspond to the antenna coils 65a to 65c. The signal detection circuit 62a detects the strength of the AC signal received by the antenna coil 65a. Similarly, the signal detection circuit 62b detects the strength of the AC signal received by the antenna coil 65b, and the signal detection circuit 62c detects the strength of the AC signal received by the antenna coil 65c. The signal detection circuits 62a to 62c are respectively driven by DC power supplies not illustrated independent of one another.

Then, a function of the wireless power feeding system 1 will be described.

### <Initial Power Transmission>

First, if AC power is sequentially fed to all or at least any one of the three power transmission coils 21, when the power transmission coil 21 closest to a power reception device 3 is energized, an oscillating magnetic field occurs to penetrate the energized power transmission coil 21 in a coil axial direction. An induced current flows through the power reception coil 31 due to magnetic field oscillation, and an oscillating magnetic field occurs to penetrate the power reception coil 31 in a coil axial direction. Thus, the respective magnetic fields of the energized power transmission coil 21 and the power reception coil 31 resonate, to be firmly coupled to each other, and AC power having a first frequency (e.g., 150 kHz) is transmitted from the power transmission coil 21 to the power reception coil 31.

AC power to be fed to the power reception device 3 from a power transmission device 2 in initial power transmission may be power small enough to drive a power transmission circuit 37.

### <Signal Transmission>

Then, the transmission circuit 37 is driven by a DC voltage received by the power reception coil 31 and rectified by a rectifying circuit 34. The transmission circuit 37 outputs a weak AC signal to the power reception coil 31.

The frequency of the AC signal to be outputted by the transmission circuit 37 is set to a first frequency and a second frequency (e.g., several thousand kilohertz) as a frequency different from its harmonic to prevent the AC signal from interfering with AC power.

The second frequency is preferably set to a frequency exceeding a frequency band in which the rectifying circuit 34 can be driven and a frequency at which the rectification efficiency of the rectifying circuit 34 is a predetermined ratio (e.g., 1/10) or less. Particularly when a diode bridge circuit is used as the rectifying circuit 34, the second frequency is preferably set to a frequency exceeding a response frequency of a diode 35 or a frequency at which an output of the diode 35 is lower than a predetermined threshold value (e.g., 1/10) of a DC characteristic.

### <Position Estimation>

Then, when an AC signal propagates from the power reception coil 31 to the power transmission devices 2a to 2c and the antenna coils 65a to 65c respectively receive AC signals each having a second frequency transmitted from the power reception coil 31, the signal detection circuits 62a to 62c respectively detect the strengths of the AC signals received by the antenna coils 65a to 65c.

Then, the position estimation unit 63 estimates any one of the power transmission devices 2a to 2c that is closest to the power reception coil 31 depending on the strength of the AC signal detected by each of the signal detection circuits 62a to 62c. Specifically, the position estimation unit 63 compares the strengths of the AC signals respectively detected by the signal detection circuits 62a to 62c and estimates that the power transmission device 2 corresponding to any one of the signal detection circuits 62a to 62c that has received the AC signal having the highest strength is closest to the power reception coil 31.

In the present embodiment illustrated in FIG. 3, the power reception device 3 (the power reception coil 31) is at a position closest to the power transmission device 2b, like in the first embodiment. Accordingly, the AC signal transmitted from the power reception coil 31 is received in the antenna coil 65b with a high strength.

On the other hand, the power reception device 3 (the power reception coil 31) is at a position offset in a coil radial direction from the power transmission devices 2a and 2c, and respective distances between the power transmission devices 2a and 2c and the power reception coil 31 are longer than a distance between the power transmission device 2b and the power reception coil 31. Therefore, the AC signal transmitted from the power reception coil 31 is not received or is received with a very low strength by the antenna coils 65a and 65c.

Hereinafter, a case where the power transmission device 2b is closest to the power reception coil 31, as described above, will be described as an example.

The controller 64 turns on a switch 24b corresponding to the power transmission device 2b that has been selected as being closest to the power reception coil 31 by the position estimation unit 63 and turns off switches 24a and 24c respectively corresponding to the other power transmission devices 2a and 2c.

### <Present Transmission>

The respective magnetic fields of the energized power transmission coil 21b and the power reception coil 31 resonate, to be firmly coupled to each other, and the AC power having the first frequency is efficiently transmitted from the power transmission coil 21b to the power reception coil 31.

Initial power transmission from the power transmission coil 21 to the power reception coil 31 is preferably performed in a predetermined cycle (e.g., every five seconds). As a result, even when a moving body 4 moves, the power transmission device 2 closest to the power reception coil 31 can be selected in real time to follow the movement of the moving body 4.

For example, when the power reception device 3 moves from the vicinity of the power transmission device 2b to the vicinity of the power transmission device 2c as the moving body 4 moves, the strength of the AC signal to be detected by the signal detection circuit 62b gradually decreases, while the strength of the AC signal to be detected by the signal detection circuit 62c gradually increases. If the controller 64 turns off the switch 24b and turns on the switch 24c at a timing at which the strength of the AC signal is reversed, power transmission to the power reception device 3 is performed without interruption so that most efficient power transmission having neither total power nor loss can be performed. When both the switches 24b and 24c are turned on before and after the timing at which the strength of the AC signal is reversed, the stability of the power transmission can be further enhanced.

Thus, the wireless power feeding system 1 according to the present embodiment is configured such that the position estimation device 6 includes the antenna coils 65a to 65c that are respectively provided to correspond to the vicinities of the power transmission coils 21a to 21c and respectively receive the AC signals and the position estimation unit 63 that estimates any one of the power transmission devices 2a to 2c that is closest to the power reception coil 31 on the basis of the strength of the AC signal received by each of the antenna coils 65a to 65c.

This configuration makes it possible to stably perform power transmission and reception by estimating any one of the power transmission devices 2a to 2c that is closest to the power reception coil 31 on the basis of the strength of the AC signal received by each of the antenna coils 65a to 65c to grasp a positional relationship between the power transmission devices 2a to 2c and the power reception device 3 with high accuracy.

### Third Embodiment

Although a case where the frequency of an AC signal to be outputted by the transmission circuit 37 is set to a first frequency and a second frequency having a frequency different from that of its harmonic has been described as an example in each of the above-described first and second embodiments, the frequency of an AC signal to be outputted by a transmission circuit 37 may be set to a frequency equal to a first frequency or within a predetermined range (e.g., +1% of the first frequency) in which a resonance state between a power transmission coil 21 and a power reception coil 31 can be maintained.

In this configuration, even if the power reception coil 31 and the power transmission coil 21 at a position closest to the power reception coil 31 are in a resonance state and the power transmission coil 21 and the power reception coil 31 are spaced a distance (e.g., 1 m) away from each other, an AC signal transmitted from the power reception coil 31 is received by any one of the power transmission coils 21a to 21c that is closest to the power reception coil 31, and is detected by any one of the signal detection circuits 62a to 62c that is connected thereto.

At this time, AC power having a first frequency and an AC signal to be outputted by the transmission circuit 37 are mixed to interfere with each other on the AC power supply 5 side of the power transmission coils 21a to 21c. However, a position estimation device 6 can estimate that any one of the power transmission coils 21a to 21c that has received the AC signal is closest to the power reception coil 31. Accordingly, the AC power and the AC signal that interfere with each other need not be distinguished. The position estimation device 6 can estimate the power transmission coil 21 closest to the power reception coil 31 by detecting an AC signal perturbed by an influence of the interference or extracting only an AC signal using a low-pass filter or a high-pass filter that does not pass the first frequency.

In the present invention, it should be understood that various modifications can be made in addition to the foregoing without departing from the spirit of the prevent invention and the present invention covers such modifications. Further, any of the above-described embodiments and modifications may be combined or all of them may be combined.

Although a configuration in which the power transmission coils 21a to 21c are arranged in a line has been illustrated and described in each of the above-described embodiments, the power transmission coils 21 may be arranged in a matrix shape, or may be arranged in a three-dimensional shape within a space.

The “strength” of an AC signal in each of the above-described embodiments includes the presence or absence of the AC signal. For example, it may be assumed that the strength of an AC signal is high when it is determined that each of the signal detection circuits 62a to 62c has received the AC signal and the strength of an AC signal is low when it is determined that each of the signal detection circuits 62a to 62c cannot receive the AC signal and there is no AC signal.

Although a case where position estimation and power transmission are performed for one power reception device 3 has been described as an example in each of the above-described embodiments, position estimation and power transmission may be performed in parallel for two or more moving bodies 4.

### REFERENCE SIGNS LIST

1: wireless power feeding system
2, 2a, 2b, 2c: power transmission device
21, 21a, 21b, 21c: power transmission coil
22a, 22b, 22c: capacitor (of power transmission device)
23a, 23b, 23c: power feeding-side resonance circuit
24a, 24b, 24c: switch
3: power reception device
31: power reception coil
32: capacitor
33: power reception-side resonance circuit
34: rectifying circuit
35: diode
36: capacitor (of power reception device)
37: transmission circuit
4: moving body
41: load
5: AC power supply
6: position estimation device
61a, 61b, 61c: filter circuit
62a, 62b, 62c: signal detection circuit
63: position estimation unit
64: controller
65a, 65b, 65c: antenna coil

1. A wireless power feeding system that transmits power using a magnetic field resonance method, the wireless power feeding system comprising:
a plurality of power transmission devices respectively including power transmission coils;
a power reception device including a power reception coil that receives AC power having a first frequency from each of the power transmission coils and a transmission circuit that outputs an AC signal having a second frequency as a frequency different from the first frequency and transmits the AC signal from the power reception coil; and
a position estimation device that estimates a positional relationship between the power transmission devices and the power reception coil on the basis of the strength of the AC signal that has propagated from the power reception coil to each of the power transmission devices.

2. A wireless power feeding system that transmits power using a magnetic field resonance method, the wireless power feeding system comprising:
a plurality of power transmission devices respectively including power transmission coils;
a power reception device including a power reception coil that receives AC power having a first frequency from each of the power transmission coils and a transmission circuit that outputs an AC signal having a frequency equal to the first frequency or within a predetermined range with respect to the first frequency and transmits the AC signal from the power reception coil; and
a position estimation device that estimates a positional relationship between the power transmission devices and the power reception coil on the basis of the strength of the AC signal that has propagated from the power reception coil to each of the power transmission devices.

3. The wireless power feeding system according to claim 1, wherein:
the position estimation device includes,
a plurality of filter circuits that are respectively connected to correspond to the power transmission coils and respectively interrupt the AC powers and pass the AC signals received by the power transmission coils, and
a position estimation unit that estimates the power transmission device closest to the power reception coil on the basis of the strength of the AC signal that has passed through each of the plurality of filter circuits.

4. The wireless power feeding system according to claim 1, wherein:
the position estimation device includes,
a plurality of antenna coils that are respectively provided to correspond to the vicinities of the power transmission coils and respectively receive the AC signals, and
a position estimation unit that estimates the power transmission device closest to the power reception coil on the basis of the strength of the AC signal received by each of the plurality of antenna coils.

5. The wireless power feeding system according to any one of claim 1, wherein:
the power reception device further includes a rectifying circuit that is provided between the power reception coil and a load to be fed with the AC power and can be driven in a predetermined frequency band, and
the second frequency is set to a frequency exceeding the predetermined frequency band or a frequency at which rectification efficiency of the rectifying circuit is a predetermined ratio or less.

6. The wireless power feeding system according to claim 5, wherein
the rectifying circuit is a diode bridge circuit having a plurality of diodes, and
the second frequency is set to a frequency exceeding a response frequency of each of the diodes or a frequency at which an output of the diode is lower than a predetermined threshold value of a DC characteristic.

7. The wireless power feeding system according to claim 1, further comprising:
a controller that controls power to be fed to the plurality of power transmission devices,
wherein the controller feeds the power to at least one of the plurality of power transmission devices depending on the positional relationship between the power transmission devices and the power reception device, which has been estimated by the position estimation device.

8. A wireless power feeding method using a wireless power feeding system that transmits power using a magnetic field resonance method and comprises:
a plurality of power transmission devices respectively including power transmission coils,
a power reception device including a power reception coil that receives AC power having a first frequency from each of the power transmission coils and a transmission circuit that outputs an AC signal having a second frequency as a frequency different from the first frequency and transmits the AC signal from the power reception coil,
a controller that controls power to be fed to the plurality of power transmission devices, and
a position estimation device that estimates a positional relationship between the power transmission devices and the power reception coil on the basis of the strength of the AC signal that has propagated from the power reception coil to each of the power transmission devices,
wherein the controller feeds the power to at least one of the plurality of power transmission devices depending on the positional relationship between the power transmission devices and the power reception coil, which has been estimated by the position estimation device.

9. The wireless power feeding system according to claim 2, wherein:
the position estimation device includes,
a plurality of filter circuits that are respectively connected to correspond to the power transmission coils and respectively interrupt the AC powers and pass the AC signals received by the power transmission coils, and
a position estimation unit that estimates the power transmission device closest to the power reception coil on the basis of the strength of the AC signal that has passed through each of the plurality of filter circuits.

10. The wireless power feeding system according to claim 2, wherein:
the position estimation device includes,
a plurality of antenna coils that are respectively provided to correspond to the vicinities of the power transmission coils and respectively receive the AC signals, and
a position estimation unit that estimates the power transmission device closest to the power reception coil on the basis of the strength of the AC signal received by each of the plurality of antenna coils.

11. The wireless power feeding system according to any one of claim 2, wherein:
the power reception device further includes a rectifying circuit that is provided between the power reception coil and a load to be fed with the AC power and can be driven in a predetermined frequency band, and
the second frequency is set to a frequency exceeding the predetermined frequency band or a frequency at which rectification efficiency of the rectifying circuit is a predetermined ratio or less.

12. The wireless power feeding system according to claim 2, further comprising:
a controller that controls power to be fed to the plurality of power transmission devices,
wherein the controller feeds the power to at least one of the plurality of power transmission devices depending on the positional relationship between the power transmission devices and the power reception device, which has been estimated by the position estimation device.
